(19) United States
(12) Patent Application Publication
(10) Pub. No.: US 2008/0197157 A1
(43) Pub. Date: Aug. 21, 2008

(54) Dispensing Device for Consumption of a Fluid with an Outwardly Movable Straw

(76) Inventors: Simon Adriaan Troost, Breda (NL); Henricus Maria Lambert Johan Gadet, Breda (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/581,375

(22) PCT Filed: Dec. 6, 2004
(86) PCT No.: PCT/IB04/04391

§ 371 Date: Nov. 27, 2007

(30) Foreign Application Priority Data
Dec. 5, 2003 (NL) 1024959

(51) Int. Cl. B67D 3/00; B65D 83/00; B65B 31/00; B65B 7/28

(52) U.S. Cl. 222/530; 53/471; 53/470; 222/402.1

(57) ABSTRACT

The invention relates to a dispensing device for a fluid with a valve which is placed on the dispensing device and has an outlet opening, and comprises a tube connected to the outlet opening of the valve, wherein the tube is at least partly flexible, the tube normally extends wholly within the casing of the cap, and before use the tube can be moved at least partly outside the casing of the cap. Such a dispensing device is hereby obtained with which a greater part of the content can be administered to the user. A more aesthetic appearance is furthermore obtained; the user is only connected to the relevant dispensing device by a tube, which gives the appearance of drinking from a glass with a straw.

The invention relates to a dispensing device for dispensing a fluid for consumption, comprising a container for a fluid with a valve which is placed on the container and has an outlet opening and a tube connected to the outlet opening.

Such dispensing devices are generally known, for instance in the form of an aerosol or pressure pack with a fluid for use in technical applications, such as an electrical contact fluid or penetrating oil. The tube is used here to apply the technical fluid at the desired position. An example hereof is known from GB 2 079 183. It is noted here that it is already known to administer such oxygen-rich gases by means of specially formed caps which are arranged on the aerosol and with which the gas leaving the aerosol can be guided to nose or mouth of the user.

The object of the present invention is to provide a dispensing device which can be used for fluids for human or animal consumption. These are understood to mean not only include drinks, such as soft drinks and the like, but for instance also gases, such as an oxygen-rich gas.

Since a large part of the gas leaving the pressure pack is lost when such a nozzle is used, the invention attempts to provide such a dispensing device wherein a larger part of the content is available for consumption and a considerably smaller part is lost.

This object is achieved in that the tube is at least partly flexible. According to the invention at least a distal tube part is further encased in a first state by the enclosing means for this distal tube part which are connected to the container. In a second state the distal tube part is movable at least partly outside the enclosing means. The tube thus normally extends completely encased, for instance within the casing of a cap, and before use the tube can be moved at least partly outside the periphery of the cap. The distal tube part is the part of the tube situated at a distance from the connection to the valve. Various other parts can be arranged between the dispensing tube and the valve.

Hereby obtained is a type of dispensing device with which a greater part of the content can be administered to the user. A more aesthetic appearance is furthermore obtained; the user is only connected to the relevant dispensing device by a tube, which gives the appearance of drinking from a glass with a straw. The nozzles for guiding the gas, which are generally provided with a medical-therapeutic appearance, are furthermore avoided.

With the invention a dispensing device is also obtained which is hygienic. The encasing or enclosing has the result that harmful bacteria have no access to the distal end of the tube, i.e. the end of the tube which is usually held in the mouth of the user during use. This end is clean. During transport from the production location to the moment of use the dispensing device is situated in the first state. This free end is stored away all this time.

The tube therefore preferably has the appearance of a straw, such as is used for drinking lemonade.

It is noted that a dispensing device for a fluid for consumption use is not shown in GB 2 079 183. In addition, no protective casing for the tube end as proposed according to the present invention is either stated or suggested in this document.

Because the enclosing means comprise a chamber in a preferred embodiment of the invention, the distal end is received in clean condition in this chamber and the tube part cannot be soiled. The tube is mounted and immediately enclosed. In another embodiment cleaning of the tube is carried out and the tube is then enclosed in the chamber.

According to a first preferred embodiment, the tube comprises in the normal state a bent tube part, the bent tube part separates the distal tube part from a tube part connected to the valve, and the distal tube part can be moved outside the casing by changing the curvature of the bent tube part.

The bent tube part can be made flexible by providing it with ribs extending all round, such as is known in straws. It is however also possible to use other configurations, such as smooth straws.

It will be apparent that, in order to be able to use the tube as a straw, it must protrude outward, for instance from the cap. Protruding of the tube in the normal situation is of course disadvantageous; this results in packing and transport problems.

These problems are avoided by this particular preferred embodiment.

Another preferred embodiment provides the measure that the bent tube part is adapted to urge the distal tube part outside the cap by resilient force. In one embodiment a biasing means is arranged. The biasing means is connected to the distal tube part and is adapted to move the distal tube part out of the dispensing device.

In order to retain or enclose the distal tube part during the normal situation, i.e. in the transport situation, in which the dispensing device is not yet opened, it is recommended that the dispensing device be provided with an end part or cap which is provided with an enclosing means for enclosing the distal tube part in the normal position.

It is possible here that at least one part of the enclosing means can be removed from the cap, for instance in the form of a removable cover or sticker, but also that the enclosing means is pivotally connected to the cap.

In the first, or normal, state the tube preferably extends wholly inside the cap. The whole tube is thus protected. For manufacturing purposes it is recommended that the tube for dispensing the fluid is an integral component of the end part/the cap.

In a further preferred embodiment, the dispensing device comprises indicator means connected to the enclosing means for indicating a state of the dispensing device. The indicator means show the state of the dispensing device. The indicator means particularly indicate whether the dispensing device is or has been in the second state. The indicator means are preferably visible. In a preferred embodiment a seal forms the indicator means. It hereby becomes possible for the user to see whether the dispensing device has already been used. The user will hereby know that the tube is possibly soiled, i.e. no longer clean.

When the dispensing device is formed by an aerosol or pressure pack, it is attractive for the valve to be a valve which can be operated by an operating element. The operating element is preferably only accessible from the outside in the second state. The enclosing means preferably encase the operating element in the first state.

This prevents it being possible to operate the operating element with the enclosing element in its normal position.

Although the above stated embodiments are in the first instance intended for an aerosol, i.e. a pressurized container which is not only filled with the fluid for administering but which also contains a propellant, it is also possible for the container to be formed by a bottle or can and for the valve to comprise a pump mechanism which can be operated by the operating element.

As already stated above, the dispensing device according to the invention is particularly suitable for filling with a fluid suitable for human consumption, such as beer, soft drinks or an oxygen-rich gas.

The invention also relates to a method for manufacturing a dispensing device for a fluid for consumption, comprising of filling a container with a fluid for consumption, connecting a tube for dispensing the fluid to the valve. The invention is characterized by enclosing a tube end in a closed space of the dispensing device. This can form part of a prefabrication method step. A dispensing device is hereby manufactured which has favourable properties in use.

The method preferably comprises of applying an overpressure in the filled container, connecting a valve to the container.

The valve is preferably part of a prefabricated cover part or sealing part of the container. The open side of the filled container is hereby wholly closed. The tube is preferably a component or integral part of an end part or cap, which end part is formed so as to have at least a transport state and a state of use. Cover part and end part are preferably formed as one part. This part is prefabricated.

The method preferably comprises of enclosing the tube under bias such that opening of the closed space before use results in a movement of the tube end out of the closed space. An effect which is favourable in use is hereby achieved.

The invention also relates to a container for a fluid, provided with a valve with an outlet opening. The invention is characterized in that the outer end has a peripheral edge, preferably of a cylindrical form, and the valve is arranged eccentrically on the outer end. The container has a central axis. The valve is arranged at a distance from the central axis. A container is hereby obtained on which a tube can be mounted, wherein the tube is arranged eccentrically on the container. This is often desirable. Because the valve is arranged eccentrically, the length of the tube or another coupling is shorter. A cost-saving is hereby achieved. In this embodiment the dispensing means can be combined with this asymmetrical container with opening and are not described separately.

Other attractive preferred embodiments are stated in the remaining sub-claims.

The present invention will be elucidated hereinbelow with reference to the annexed figures, in which:

FIG. 1 shows a perspective view of a dispensing device according to the first embodiment of the present invention;

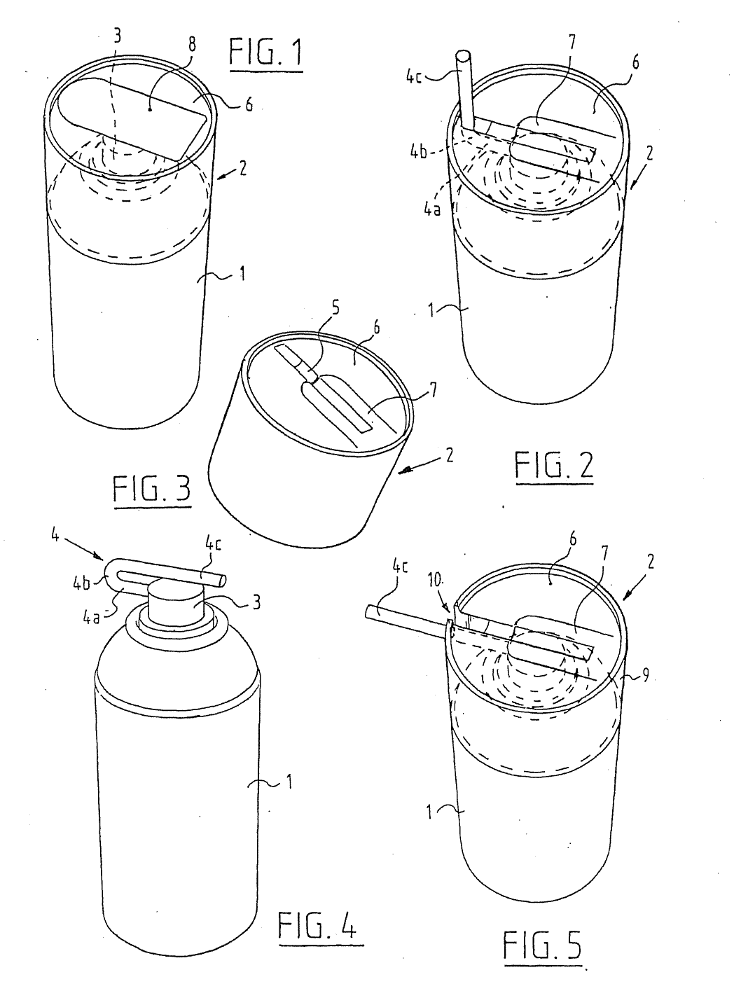

FIG. 2 shows a view corresponding with FIG. 1, wherein the enclosing element is removed and the tube is bent upward;

FIG. 3 is a perspective view of the cap of the embodiment of FIGS. 1 and 2;

FIG. 4 is a perspective view of the embodiment of FIGS. 1 and 2 with cap removed but with tube connected;

FIG. 5 shows a perspective view of a second embodiment of the invention;

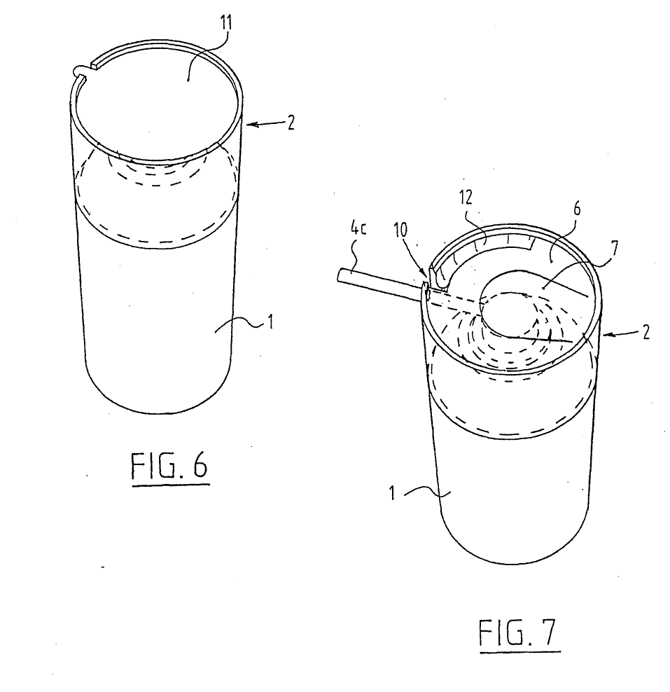

FIG. 6 shows a perspective view of a third embodiment in the normal situation;

FIG. 7 shows a view corresponding with FIG. 6 in the opened situation;

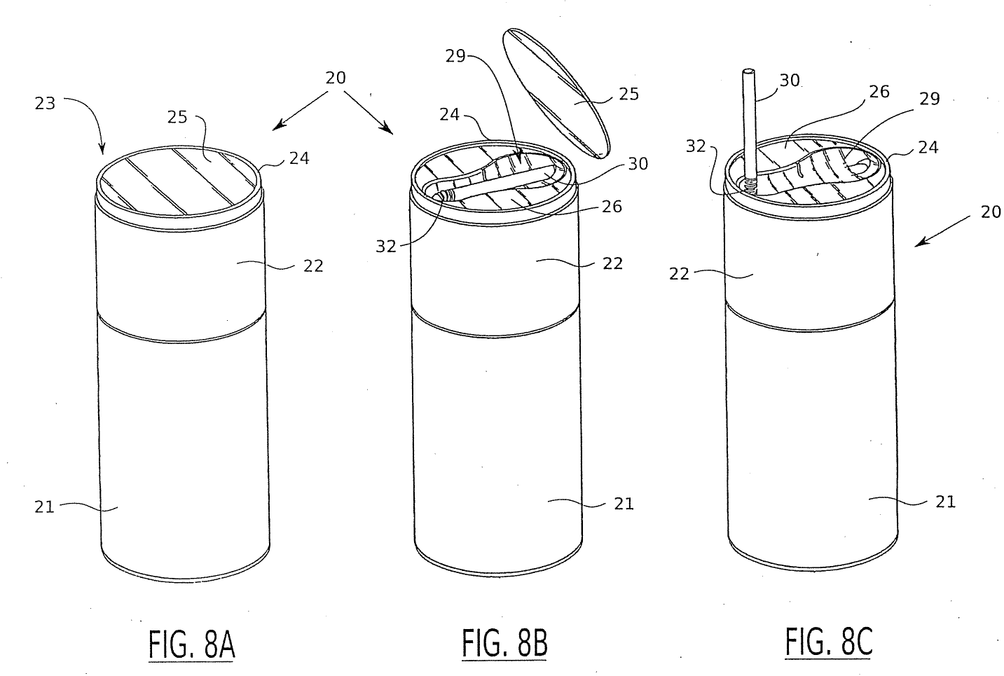

FIGS. 8a-8c show a perspective view of a fourth embodiment;

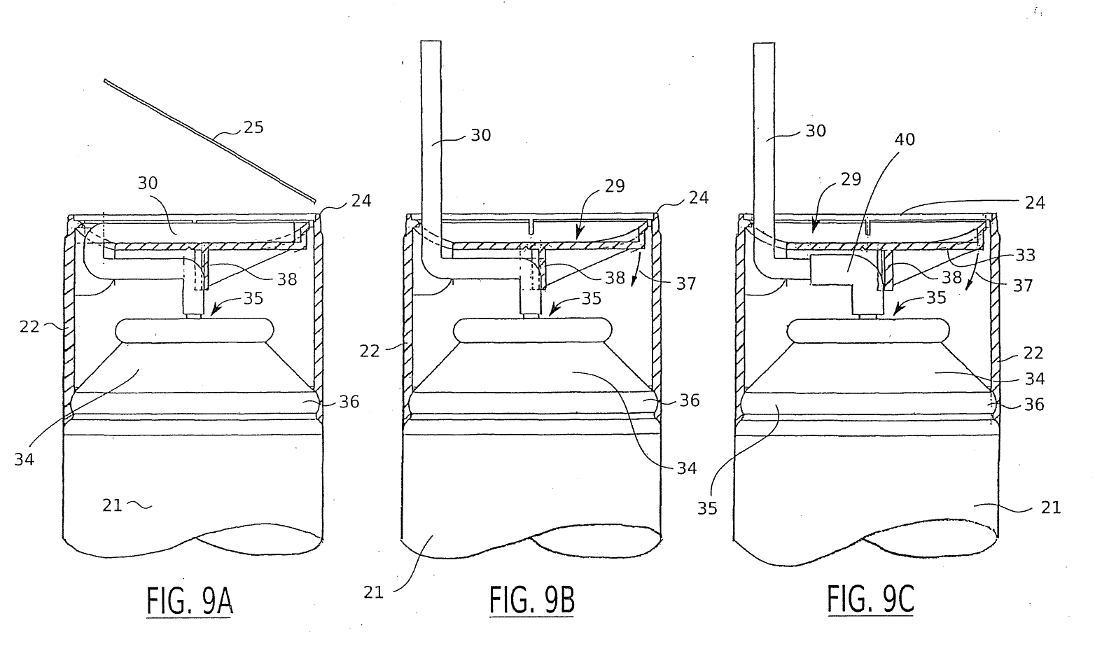

FIGS. 9a-9b show a cross-section along the line IX of the fourth embodiment according to FIG. 8;

FIG. 9c shows a cross-section along the line IX of the fifth embodiment according to FIG. 8;

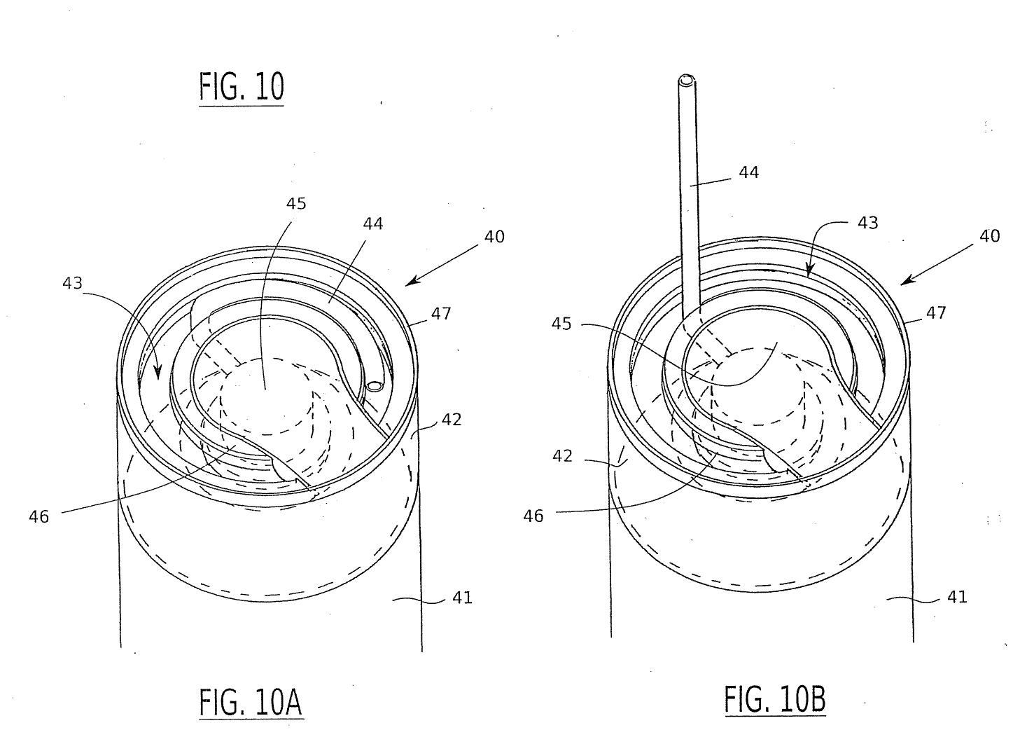

FIGS. 10a and 10b show a perspective view of a sixth embodiment;

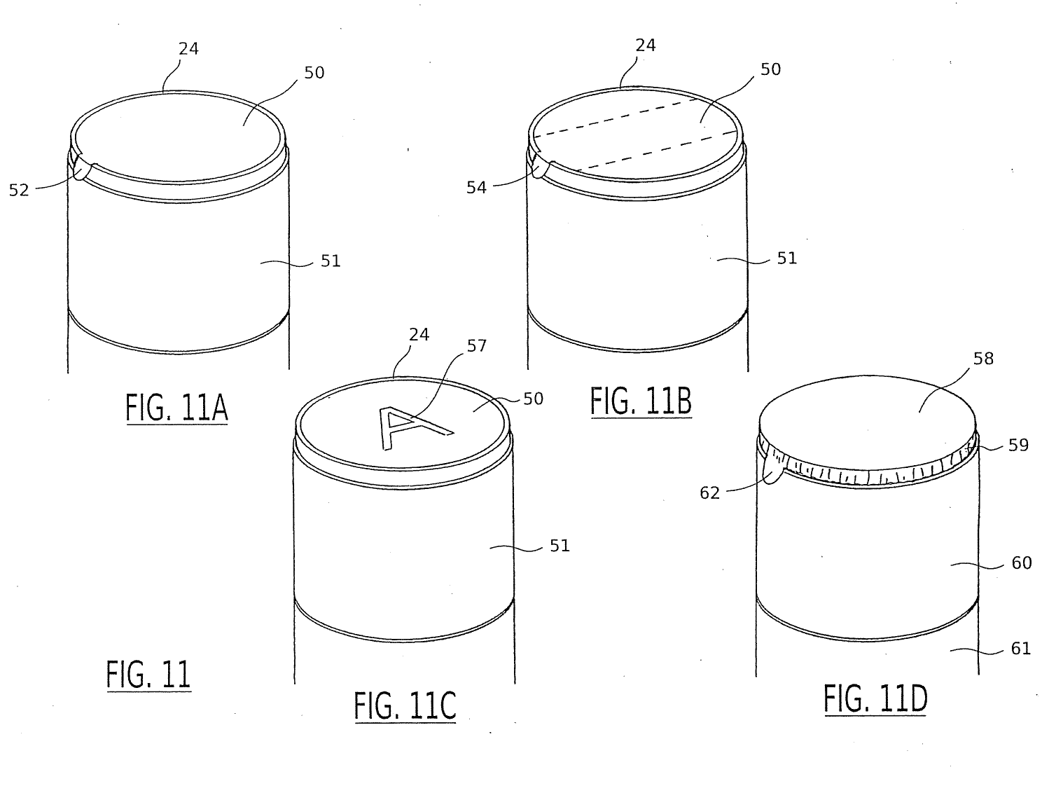

FIGS. 11a-11d show an embodiment of a seal for use in the invention;

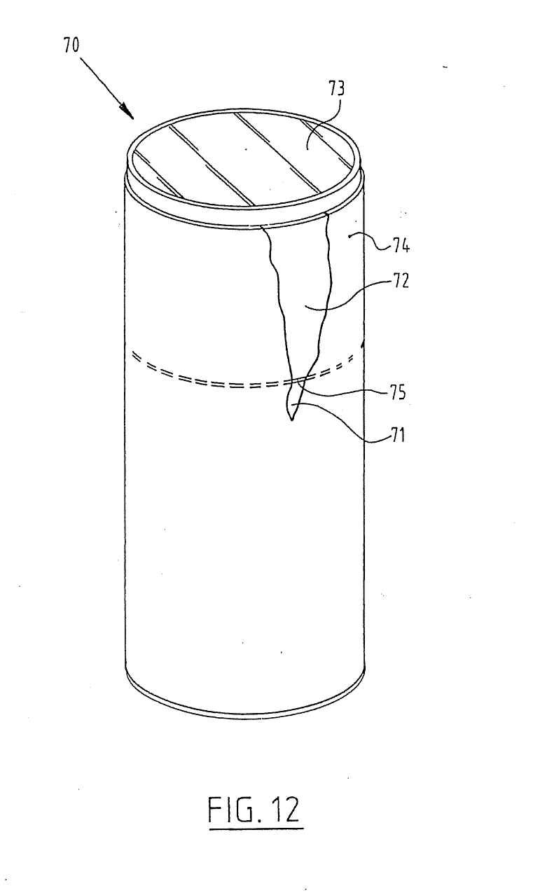

FIG. 12 is a perspective view of another embodiment of the packaging device;

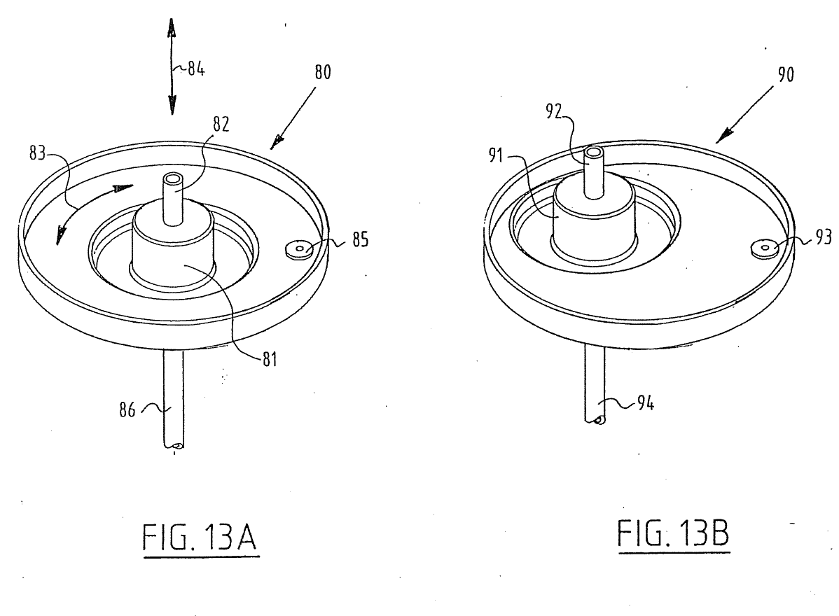

FIGS. 13a-13b show two embodiments of the container cover;

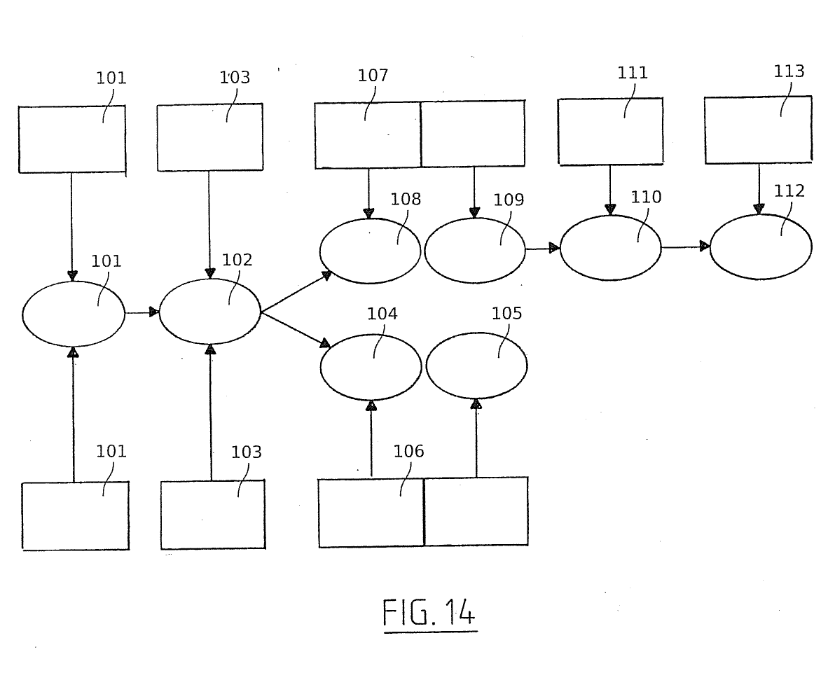

FIG. 14 is a flow diagram of a method according to the invention.

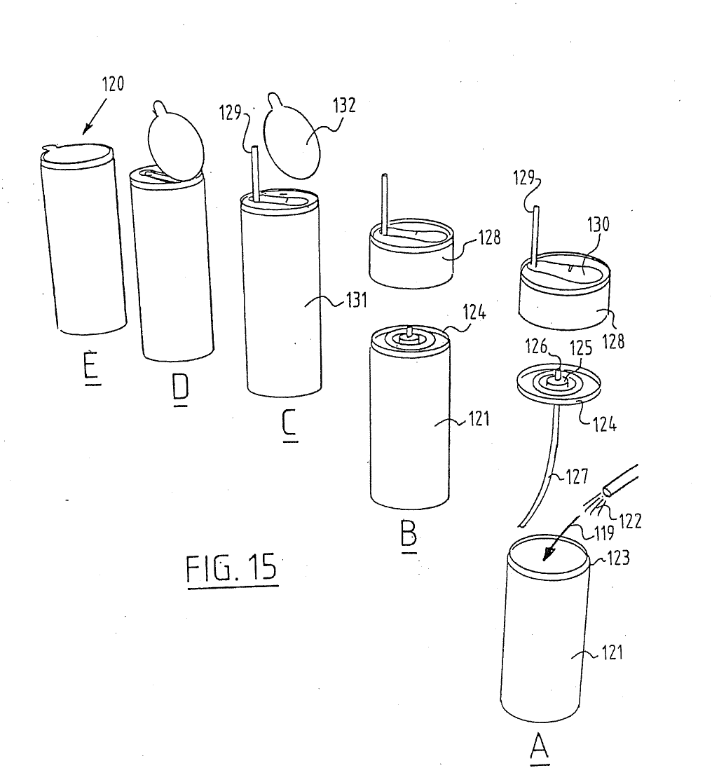

FIG. 15 show the manufacture of the dispensing device according to the invention.

FIG. 1 shows a dispensing device which is formed by an aerosol 1 and a cap 2 placed thereon.

Aerosol 1 is formed by a per se known metal can which is closed at its top by a valve 3. It is pointed out here that cap 2 is arranged clampingly in per se known manner around an upper edge of aerosol 1. As is shown in FIG. 4, a tube 4 is connected to valve 3.

As shown in FIG. 4, the tube 4 is bent. Tube 4 therefore comprises a part 4a connecting to valve 3, a bent part 4b connecting to part 4a, and a distal part 4c.

Parts 4a,b,c are herein shown in FIG. 4 in the position in which they are situated in the normal state.

Part 4c herein extends in a groove 5 arranged in the upper surface 6 of cap 2, as is shown in FIG. 3. An operating element 7 is moreover arranged in upper wall 6. The groove 5 also extends in operating element 7.

When operating element 7 is depressed, valve 3 is pressed downward so that it is opened. Operating element 7 is provided for this purpose with a downward-extending protrusion not visible in the drawings.

In the normal, i.e. unopened, state a sealing element 8 is arranged on the upper wall 6 of the cap. This sealing element is a cover which, like the cap, is manufactured from plastic. It may even be moulded in order to facilitate production. Such a normal situation is shown in FIG. 1. The normal state is understood to mean the state in which the dispensing device is offered for sale.

When, after purchase, a consumer wishes to use such a dispensing device, he removes sealing element 8 or, if it is connected pivotally to the cap, folds it back, whereafter the situation is obtained as shown in FIG. 1. The distal tube end 4c herein extends perpendicularly of upper wall 6 of cap 2. In this situation the distal end of tube 4 can for instance be reached with the mouth, and the content of the aerosol can be consumed by taking the tube into the mouth. In order to gain access to the content, operating element 7 must be pressed downward so that the valve 3 of the aerosol is opened.

As already stated in the preamble, the aerosol can for instance be filled with an oxygen-rich gas which has a refreshing effect. It is however possible instead to accommodate drinks in the dispensing device, such as soft drinks or for instance stimulant drinks, such as drinks with caffeine added. Alcoholic drinks can of course also be used.

As already stated, it is possible to use an aerosol, i.e. a combination of a drink and a propellant, wherein the valve normally serves only to keep the aerosol closed, and is opened when pressed in.

It is however also possible to make use of other types of dispensing device, wherein the content is not stored under pressure, and the content must be urged to the tube for instance by pumping. Here the valve is replaced by a pump mechanism which, when depressed, builds up a pressure in the dispensing device which drives the contents outward.

In this latter case a propellant is of course not necessary.

It is of course possible to make variations to the embodiment shown here. FIG. 5 for instance shows an embodiment wherein the distal part 4c of the tube extends in the direction of upper wall 6 of the cap, i.e. transversely of the direction of movement of the valve. A recess 10 is arranged for this purpose in side wall 9 of the cap. It will be apparent that numerous other variations can be used.

It is otherwise pointed out here that the automatic movement of distal part 4c of the dispensing device to its exposed state takes place by means of the resilience of the tube, i.e. the resilience of part 4b. It is possible to construct other types of mechanism, such as a spring, which can even be integrated into the cap.

In the embodiment shown in FIG. 6, use is made of a sticker 11 as enclosing element. This sticker is adhered releasably to the upper surface 6 of the cap.

When sticker 11 is released and removed, the situation shown in FIG. 7 is created. The upper surface 6 of the cap is herein provided with a curved recess 12. The tube is hereby placed in the cap in bent state. This embodiment further differs in the ergonomic design of the operating element.

FIG. 8a shows a perspective view of a fourth embodiment of a dispensing device 20. Dispensing device 20 consists of a container 21 and a cap 22 arranged thereon. Both the container and the cap have a substantially cylindrical shape. Container 21 contains a fluid for consumption which can be dispensed via an opening (not shown). The opening is incorporated in cap 22. The cap covers the opening completely. The opening of the container is incorporated in cap 22. The opening can be closed with a valve.

Cap 22 is mounted in known manner on container 21. An adhesive can be used, or a suitable clamping or snapping means can be used for the connection.

The free upper side 23 of cap 22 has an edge 24 which protrudes. The edge is a peripheral edge and surface 26 is covered with a seal 25. Seal 25 can be a sticker. Seal 25 can be removed from the upper end of cap 22, as shown in FIG. 8b. Seal 25 can be provided with an image 27 which can be used for advertising purposes. By applying the seal, with which the cap is sealed, an extra surface is obtained for displaying for instance advertising images. The seal, a round disc in the shown embodiment, can in addition be used for other applications, such as for collecting purposes.

Seal 25 is connected to cap 22 in suitable manner. An adhesive can be used but edge 24 can also protrude slightly inward around the periphery so that seal 25 is clamped. Seal 25 is for instance provided with a lip 28 which can be grasped by the hand of the user to remove the seal. The seal in the shown embodiment can be detached from cap 22. The sticker can be torn off or mechanically removed. In another embodiment a pivoting connection is possible.

The upper surface 26 of cap 22 is left clear by removing the seal 25. This upper surface is provided with a recess 29. Recess 29 is sealed using the seal, whereby a cavity is formed. Together with the cap, the seal is an enclosing means for tube end 30.

Received in cavity 29 is a tube 30 which in the sealed situation shown in FIG. 8a is completely sealed off from the outside world. The situation shown in FIG. 8a can be designated the transport situation or first state, wherein tube 30 is stored hygienically. FIG. 8b shows a transitional situation, while FIG. 8c shows the situation of use or second state of dispensing device 20.

Tube 30 is placed in the situation of use by a movement according to arrow 31. The movement 31 can be achieved by means of biasing of the tube under seal 25, or can be made by the user him/herself.

Tube 30 is provided with a ribbed part 32 whereby it is possible to bend tube 30 without damage.

In one embodiment the seal can be re-placed. Use of the device can hereby be stopped and the seal re-placed in the transport situation.

In a preferred embodiment indicator means are present which indicate breaking of the seal from the first or transport state to the situation of use. It is hereby possible for the user to detect wether dispensing device 20 has already been in the situation of use. These indicator means can for instance be formed by a seal. The skilled person will be familiar with different options.

A push button 33 is formed in recess 29. The user can operate push button 33 with a finger. The push button is movable in cap 22. Pressing push button 33 results in the fluid being released from container 21 via tube 30. Tube 30 is connected to the opening of container 21. This is shown in FIG. 9.

Cap 22 can be formed by injection moulding. The cap is the housing of the operating mechanism of the dispensing device according to the invention. The cap is the housing for tube 30 and the cap is a housing for seal 25.

FIG. 9a shows a cross-section along line IX of FIG. 8b. Container 21 is provided with a tapering, concentric end part 34 which is provided with an opening 35 in the form of a protruding tube part.

Container 21 can have one or two parts. The shape shown here is cylindrical but the shape may also be oval, flat oval or angular. In the two-part embodiment one outer end, the end over which cap 22 is arranged, is provided with an end part in which opening 35 is arranged. This end part can be embodied in diverse ways according to the invention.

A fluid is arranged in container 21. In one embodiment a pressure medium is also added to the content of the container. This can take place after arranging of the fluid via a filling nipple and the like. The filling nipple can be arranged on the upper side or on the underside.

According to another method, the container is manufactured with cover and, before the cover is attached to the container, a gas is added to the container. This is known as “under the cup” production. A container with a propellant such as nitrogen (N₂) can hereby be provided in advantageous manner.

When an overpressure is present in container 21 the fluid can flow outside via opening 35 with a movement of opening 35, for instance a tilting of opening 35. In the embodiment shown in FIGS. 9a and 9b, tube 30 is directly connected to opening 35. FIG. 9a shows an intermediate state, while FIG. 9b shows the situation of use or second state.

In the cross-section of FIGS. 9a and 9b can also be seen how cap 22 is arranged over a peripheral edge 36 of container 21. Cap 22 has clamping means on the part arranged around container 21, which means can be arranged clampingly around longitudinal edge 36. The connection is a hooking connection.

The operating button or push button 33 can be moved as according to arrow 37, with the effect that a projection 38 connected to push button 33 tilts the opening 35. Tilting of opening 35 will result in known manner in a valve being opened, whereby fluid will flow outside from the container through tube 30 by means of the prevailing overpressure. In the situation of use the dispensing device is preferably held upright with the cap on the top. Connected to tube 3d is a tube 39 which is shown in dotted lines and which protrudes into the interior of container 21 and which preferably debouches with an opening close to the bottom of container 21.

FIG. 9c shows a similar embodiment wherein tube 30 is connected by means of a stem 40 to tube 35 of container 21. Through use of the stem a good connection can be made between tube part 35 and tube 30.

Stem 40 can be embodied in a particular manner. The connection of tube 30 to stem 40 can be permanent, as shown here, but in another embodiment the connection is formed only after the actuator, i.e. operating element 33, is pressed as according to arrow 37. The connection between tube and stem is activated after a movement in accordance with the tilting mechanism shown with arrow 37. The connection between the distal tube end and the valve is possible in many different ways. The skilled person will be able to select a particularly efficient manner on the basis of the prior art.

The connection between cap 22 and container 21 is a liquid-tight and/or gas-tight sealing. The cap is fixed onto the container. This can take place via a seam-folding method.

Container 21 can be filled with different fluids. Other applications are foam products and gases. In yet another embodiment, a medication can also be accommodated in the container.

According to an embodiment which is not shown, instead of working with an overpressure in container 21, use can be made of a pump mechanism which can be operated using push button 33. Operation with a push button causes a pumping action whereby fluid is drawn out of container 21 and carried outside through tube 30. The skilled person will be familiar with embodying a pump mechanism.

Push button 33 and protrusion 38 form part of the operating mechanism of the dispensing device according to the invention. The skilled person will be familiar with being able to embody this operating mechanism in diverse ways. The operating mechanism in any case comprises means for activating the dispensing of a fluid. With the operating mechanism both the pump and the container can be operated under pressure.

It will be apparent that numerous variations of the shown embodiments can be made without departing from the invention.

FIG. 10 shows a perspective view of a sixth embodiment of the dispensing device 40 according to the invention, wherein a container 41 is provided with an end part 42 which is provided with an annular recess 43 in which a tube 44 is received. FIG. 10a shows an intermediate state wherein the seal which would normally close off the recess and tube 44 has already been removed, and before the dispensing device is brought into the situation of use, as shown in FIG. 10b. The tube is now arranged away from the centre in recess 43. In the centre is formed the push button 45 which can be brought into direct contact with valve 46, which is shown schematically with dotted lines. Pressing push button 45 results in the valve being opened, whereby fluid received in container 41 is carried out through tube 44 via valve 46. Different seals can be used. The sealing can be received in the space formed within the peripheral edge 47 of cap 42. Cap 42 is placed on an end of the container which is provided with an opening over which valve 46 is arranged.

FIGS. 11a-11d show four embodiments of the seal on the end part of a dispensing device according to the invention.

FIG. 11a shows a seal 50 which is arranged on an end element 51. Seal 50 is provided with a lip 52. The user can grasp the lip 52 and use it to pull open the seal 50. The connection is then broken.

FIG. 11b shows a seal 53 provided with a lip 54. Seal 53 is provided with two tear lines 55. The user can remove the part between the tear lines using lip 54. Such an embodiment is an example of a means for indicating whether the dispensing device has been opened.

FIG. 11c shows a device wherein seal 56 is provided with a symbol 57. This can be an advertising message. A schematic advertising message is shown in FIG. 11c.

FIG. 11d shows a seal 58 which is arranged with an edge 59 round the outer end 60 of dispensing device 61. A lip 62 protrudes from longitudinal edge 59. Longitudinal edge 59 is arranged around the outer end 60. The longitudinal edge is seam-folded round the outer end.

FIG. 12 shows dispensing device 70 according to the invention. This consists of a container, which forms the lower cylindrical part, and an upper part 72. Upper part 72 is placed over the container, which is provided with a valve. The upper part or cap 72 is provided with a seal or indicator means 73 with which the distal tube end is accommodated in a closed space for the transport state, wherein seal 73 can be removed to bring the dispensing device 70 into the situation of use. The dispensing device 70 consisting of two parts is enclosed by means of a sleeve 74, which is shown partly broken-away. The sleeve covers the whole package, in any case around the boundary 75 indicated with broken lines between container part 71 and upper part 72. This boundary is sealed by means of sleeve 74 and the user of the device will not be able to see the two parts. In the manufactured state the dispensing device 70 has the appearance of being manufactured from one part. Operation is otherwise similar to that of previous embodiments.

FIG. 13a shows a cover part 80 which can be used to cover a container filled with fluid. According to this embodiment, the container is again cylindrical. Cover part 80 is arranged on this container. A valve 81 is arranged in known manner in the cover part, which valve is provided with a tube 82 via which fluid can be dispensed. By moving the valve as according to one of the arrows 83,84, respectively tilting or pressing, the valve will be opened whereby fluid can flow out via tube 82. Cover part 80 is also provided with a filling nipple 85 via which a pressure gas can be arranged in the closed container. After placing of the cover on the open end of the container filled with a fluid for consumption, the content of the container is sealed. Via filling nipple 85 another pressure medium, for instance nitrogen gas, can be added to the container, for instance via a syringe. An overpressure is hereby created in the container. Overpressure can cause the fluid which is arranged in the container and which is in communication with valve 81 via tube part 86, to flow out of tube part 82.

FIG. 13b shows another embodiment which has particular advantages. The cover part 90 according to this other embodiment can be placed on a container of any random form, in the shown embodiment a container with in any case a circular open end. Valve 91 is formed in the same manner as the valve of the first embodiment according to FIG. 13a, but is placed out of centre. The eccentrically arranged valve 91 is provided with a tube part 92. In the assembled state, when a cap is arranged, as shown in the cross-section of FIG. 9, a particular advantage is achieved, since with the eccentrically placed valve 91 and tube part 92 the connection to the enclosing space can be embodied with a smaller proximal tube end, or without one, when compared to FIGS. 9a-c. When a tube part connected to the distal end part according to FIGS. 9a-c is mounted on tube 92, a saving of this tube part material will here be made when the distal part protrudes inward from an eccentric part as according to the embodiment of FIGS. 8a-c. A further cost saving is hereby achieved. Cover part 90 is provided with a filling nipple 93 and provided with a tube part 94 which is arranged in the container.

FIG. 14 shows on the basis of a flow diagram the method for manufacturing a dispensing device according to the invention as compared to the prior art. With 100 is designated the step wherein the container is manufactured. This is possible by forming the container from basic material 101, for instance by rolling the cylindrical shape of a container as shown in the first embodiment. Different materials can be used. Different processing techniques can be used. The wall thickness is chosen such that it is sufficient for the overpressure situation. The skilled person will be familiar with calculating and applying the correct dimensions. Different manufacturing techniques can be used, such as the application of ridges. In addition, the container can be drawn from the basic material. Decorations can be arranged, such as ribs and/or grooves.

Once the container is formed, the product or the fluid for human or animal consumption 103 is arranged in the container in step 102. Different products can be used, including fluids for consumption, also including foam products, medication and gases.

Both the manufacture of the container and filling of the container are known methods and can be carried out as known from the prior art, and will not be further described here.

The prior art now continues with step 104 and step 105, wherein respectively an end is placed on the container for closing thereof, and this end is fixedly mounted.

According to the invention a part 106 provided with the valve is placed on the container. This part comprises for instance a tube which protrudes into the container as far as the bottom of this container. This cover part of the container is for instance provided with a pressure valve or a tilting valve which, when operated, makes an open connection between the tube placed in the container and an external part.

Different end parts or cover parts of the container can be applied, as long as a valve means is provided which, when operated, provides an open connection to the content of the container. The cover part can be provided with a single valve which, in co-action with an overpressure in the container, results in the fluid being carried outward, or can be embodied with a pump which can be operated.

In step 107 the cover part is provided as a semi-manufacture. The cover part can be provided in advantageous manner with a stem for making connections later.

In step 108 the part 107 is fixed onto the container by means of for instance a vacuum crimper or other techniques 109. This technique is comparable to the prior art.

In step 110 a propellant is supplied according to one embodiment of the invention. In the method shown according to FIG. 14, the propellant is added via a filling point, for instance by means of a needle which can be received in the interior of the container. According to another technique, the end part is mounted at step 106 and 108 by so-called under-the-cup filling, wherein a propellant is fed into the open container under high pressure and it is closed very rapidly. Propellant means are supplied via a propellant supply 111.

In step 112 the cap manufactured in step 113 is placed over the now manufactured container. Different connecting techniques can be used. The tube of the cap, which is manufactured integrally in step 113, can be connected to the valve or the stem. The cap can then be connected to the container.

According to the invention a dispensing device is provided by first manufacturing the container, and closing the container. The cap part or end part is arranged on the closed container, wherein this end part is at least connected to an outlet of the container and wherein this end part also provides a distal tube end which is enclosed in a first state and which can be left clear in a second state. According to the invention an advantage is achieved in this manufacturing method, wherein the dispensing device according to the invention is manufactured by combining a number of prefabricated parts. The different parts can be produced separately of each other in cost-effective manner and combined. The combination according to the invention is particularly advantageous since the separation of respective parts can take place in cost-effective manner. The manufacture of the four different components can take place using different materials, wherein the most cost-effective manufacturing method can be applied for each of the components.

The cap manufactured in step 113 is provided with the sealing in the form of a seal, for instance as according to any of the embodiments shown in FIG. 10.

According to a preferred embodiment, the cap is formed at step 113 by injection moulding, preferably from one part.

FIG. 15 shows the manufacture of a dispensing device 120 in five steps. A container part 121 is manufactured in known manner. The container can be filled with a fluid, shown schematically with 122. Fluid is placed in the container according to arrow 119. On the open end 123 of the container is arranged a cover part 124, for instance a cover part according to any of the embodiments of FIG. 13. Cover part 124 is provided with a valve with an opening 126. The fluid arranged in container 121 can be carried to valve 125 via tube 127. Cover part 124 is mounted on container 121 in step (b). The fluid is arranged in the container. During mounting of cover part 124 on container 121 a pressure medium can be received in the container. The pressure medium can also be added via a filling nipple. In another embodiment the valve is not only a valve but also a pump device. Cover part 124 is connected sealingly to container 121 in known manner as according to the prior art. The fixing method is in any case suitable for sealing closure of the container while it is provided with an overpressure. Different sealing techniques are available for this purpose.

The end part 128 is provided as semi-manufacture and is provided in the situation shown in (a) with a distal tube part 129 which protrudes from a recess 130.

In step (c) the end part 128 is placed on the container provided with cover part 124, and is also sleeved with a sleeve 131, whereby in known manner a dispensing device 120 is obtained wherein it is not possible to see on the outside that it consists of two parts 121 and 128.

In step (d) the distal outer part 129 is placed in recess 130 and a seal 132 is arranged on the outer end of end part 128. The first state of the dispensing device according to the invention is hereby achieved in (e) in FIG. 15. Seal 132 can be removed, whereby the distal tube end 129 is released and brought into the situation of use.

1-24. (canceled)

25: A dispensing device for a fluid for consumption, comprising a container for the fluid with a valve which is placed on the container and has an outlet opening, and a flexible tube connected to the outlet opening for dispensing the fluid, wherein in a first state at least a distal tube part is encased by enclosing means for enclosing the distal tube part, and in a second state the distal tube part is movable at least partly outside the enclosing means.

26: The dispensing device as claimed in claim 25, wherein the enclosing means comprise a chamber which is arranged on the dispensing device and which is inaccessible in the first state.

27: The dispensing device as claimed in claim 25, wherein the dispensing device is filled with a fluid suitable for human consumption.

28: The dispensing device as claimed in claim 25, wherein in the normal state the tube comprises a bent tube part, that the bent tube part separates the distal tube part from the tube part connected to the valve, and that the distal tube part can be moved outside the enclosing means by changing the curvature of the bent tube part.

29: The dispensing device as claimed in claim 28, wherein the bent tube part is adapted to urge the distal tube part outside the enclosing means by means of resilient force.

30: The dispensing device as claimed in claim 25, wherein the dispensing device comprises a cap which is provided with a cavity for receiving the distal tube part in the first state.

31: The dispensing device as claimed in claim 30, wherein the cap is provided with an enclosing element for enclosing the distal tube part in the first state.

32: The dispensing device as claimed in claim 25, wherein a part of the enclosing means can be removed from the dispensing device.

33: The dispensing device as claimed in claim 32, wherein the enclosing means comprise a sticker.

34: The dispensing device as claimed in claim 30, wherein the enclosing means form part of the cap and can be broken off the cap.

35: The dispensing device as claimed in claim 30, wherein the enclosing means are pivotally connected to the cap.

36: The dispensing device as claimed in claim 30, wherein the valve is a valve which can be operated by an operating element and that the operating element is only accessible from the outside in the second state.

37: The dispensing device as claimed in claim 36, wherein the cavity for the distal part of the tube extends adjacently of the operating element.

38: The dispensing device as claimed in claim 25, wherein the tube part connecting to the valve extends transversely of the direction of movement of the valve in both the first state and the second state.

39: The dispensing device as claimed in claim 38, wherein in the second state the distal tube part extends substantially in line with the tube part connecting to the valve.

40: The dispensing device as claimed in claim 38, wherein in the second state the distal tube part extends substantially transversely of the tube part connecting to the valve.

41: The dispensing device as claimed in claim 25, wherein the dispensing device is a container under pressure provided with a closing valve and that the operating element is adapted to operate the closing valve.

42: The dispensing device as claimed in claim 25, wherein the dispensing device is a bottle and that the valve comprises a pump mechanism which can be operated by the operating element.

43: The dispensing device as claimed in claim 25, wherein the container is provided with indicator means connected to the enclosing means, wherein the indicator means at least indicate that the dispensing device is in the second state.

44: The dispensing device as claimed in claim 25, wherein the container has a circular cross-section and that the valve is arranged eccentrically on the container.

45: A method for manufacturing a dispensing device for a fluid for consumption, comprising of filling a container with a fluid for consumption, connecting a valve to the container, connecting to the valve a tube for dispensing the fluid, wherein by enclosing a tube end in a closed space of the dispensing device.

46: The method as claimed in claim 45, further comprising enclosing the tube under bias such that opening of the closed space before use results in a movement of the tube end out of the closed space.

47: The method as claimed in claim 45, wherein the method further comprises of applying an overpressure in the filled container.

48: A container for a fluid for consumption, comprising a container provided with an outer end on which an opening with valve is arranged, wherein the outer end has a peripheral edge and that the opening is arranged eccentrically on the outer end.

49: The dispensing device as claimed in claim 25, wherein the valve is a valve which can be operated by an operative element and that the operative element is only accessible from the outside in the second state.
